(19) United States
(12) Patent Application Publication
(10) Pub. No.: US 2014/0304061 A1
(43) Pub. Date: Oct. 9, 2014

(54) Obtaining Metrics for Online Advertising Using Multiple Sources of User Data

(71) Applicant: Facebook, Inc., MenloPark, CA (US)

(72) Inventor: Sean Michael Bruich, Portland, OR (US)

(73) Assignee: Facebook, Inc., MenloPark, CA (US)

(21) Appl. No.: 14/249,160

(22) Filed: Apr. 9, 2014

Related U.S. Application Data
(60) Provisional application No. 61/810,248, filed on Apr. 9, 2013.

(51) Int. Cl. G06Q 30/02

(52) U.S. Cl. CPC G06Q 30/0242
USPC 705/14.41

(57) ABSTRACT

A system for obtaining metrics for online advertising uses multiple sources of user data, including panel data, social networking system data, and user data from other online service providers. An advertising impression system notifies each data source when an advertising impression occurs for an advertising campaign. The user data sources identify users corresponding to the impression by referencing a look-up table that matches a user ID at the advertising impression system with the user ID of users at the user data source. Each user data source generates a demographics report based on the user data known to that user data source. The user data sources transmit the demographics reports to a data aggregator, which determines estimated viewing statistics based on the various user data sources without revealing personally identifiable information from the user data sources.

### CROSS REFERENCE TO RELATED APPLICATIONS

This application claims the benefit of U.S. Provisional Application No. 61/810,248, filed Apr. 9, 2013, which is incorporated by reference in its entirety.

### BACKGROUND

This disclosure generally relates to the field of computer data storage and retrieval, and more specifically, to deriving information for estimating viewership of digital content such as online advertisements.

Disseminators of digital content via the Internet are often interested in estimating the viewership of that content. For example, advertisers that provide digital advertisements for display on websites are interested in estimating the number of impressions (total separate displays) that a particular advertisement produced with respect to different demographic groups having attributes of interest, such as different age groups, males or females, those with particular interests (e.g., tennis), and the like.

In the context of television advertisements, selected surveying panels of households and/or individuals can be directly or indirectly surveyed regarding their television viewing habits. But these panels must be of a substantial size to be statistically representative, and thus panels are of little utility in contexts where there is not a large audience to be surveyed. For example, few, if any, individual websites have the number of viewers needed to form a panel providing sufficient accuracy.

Some websites, such as social networking sites, have a very large user base and thus have access to a wealth of demographic and statistical data. For example, user data on social networking sites typically includes information such as age, sex, and interests, as well as users' historical reactions to advertisements previously presented. However, the user base of these social networking sites typically does not perfectly represent, demographically, the population in general or that of another website on which advertisements might be placed. For example, the user demographics of a given social networking site are unlikely to perfectly match those of an online news website. Thus, although the user data on a social networking site could be directly used to estimate the effectiveness of an advertisement placed on the example online news website, the accuracy of the estimate could be enhanced.

Machine-based tracking techniques, such as the use of cookies employed by many advertising providers for tracking user reactions to advertisements, result in a large volume of data drawn from across many different websites. However, such data is associated with a particular computing device (e.g., a personal computer), rather than with an individual. In contrast, social networking sites and other login-based systems avoid the problems of multiple people sharing the same computer device, or one person using multiple distinct computer devices.

Additionally, users of online systems may interact with a variety of data sources and provide different information to each. Each data source may also be governed by a privacy policy that may not allow for sharing of personally identifiable information. For example, one data source may know that a user is a male between ages 25 and 35, a second data source may know that the user is male and graduated from college in 1999, and a third data source may know the user is between ages 25 and 35 and lives in California. Since each data source typically maintains its data separately, an advertiser is limited in knowing that an advertisement served to the user was served to a male between ages 25 and 35 who graduated from college in 1999 and lives in California.

### SUMMARY

A system is provided for determining the advertising reach and impressions of an advertisement, broken out by demographic groups. The system obtains metrics for online advertising using multiple sources of user data, such as panel data, social networking system data, and user data from other online service providers. In such a system, it would be valuable to correlate information from the multiple data sources to determine demographics and reach for advertisements without exposing actual data known by each data source, which may include personally identifiable information, to the other data sources.

A system for obtaining metrics for online advertising accesses data from multiple user data sources, which may include panel data, social networking system data, browser data, and user data from other online service providers. Each of the data sets may comprise demographic information about the users and statistics about the users. The data resulting from the combination may be used to compute an estimation model at an advertising server that more accurately estimates the users' viewership of content than would the use of the data of any given one of the different data sets when taken in isolation.

In one embodiment, the estimated viewing statistics produced by the model for an advertisement or other content comprise estimated statistics for values of a set of demographic attributes of interest. The estimated statistics may include a reach value (i.e., a number of distinct users estimated to have viewed the advertisement), an impression value (i.e., a total number of times the advertisement was displayed), and/or a frequency value (i.e., a number of times that an average user is estimated to have viewed the advertisement). These values may be reported based on the demographic information about the viewers. For example, the values of demographic attributes of interest might include a set of age ranges or sex. Use of the rich data sets from social networking systems, for example, allows analysis of additional demographic attributes, such as specific interests (e.g., a particular sport, such as tennis), education level, or number of friends that are entered by users of the social networking systems or inferred based on user activity. Viewing statistics with respect to combinations of demographic attributes (e.g., males aged 20-24) may also be analyzed.

The data sets are combined, resulting in a model that estimates viewing statistics for content for which the viewing statistics have not already been verified. The estimated viewing statistics may include values for the individual demographic attributes and/or combinations thereof, and aggregate values across all demographic groups (e.g., an estimated total number of impressions). The techniques that can be used to produce the estimation model include, for example, supervised learning and Bayesian techniques.

To avoid data leakage that could occur if the different user data sources were to share their user data with one another, the advertising impression system provides a hashed user ID to the user data sources. The user data sources match the user ID to user identifiers at the user data source and provide demographics information about the users to a data aggregator.

The user advertising impression is received by an ad impression system that matches the client with a user ID associated with the ad impression system and determines the advertising campaign that the user received. The ad impression system provides a hash of the advertising impression system user ID and a hash of the advertising campaign to several user data sources. The user data sources each maintain a table matching the ad impression system user ID hashes with a user ID at the user data source. This enables each user data source to maintain a log of the source IDs that viewed an advertising campaign. Each user data source periodically transcribes the log to a report indicating general user demographics of users who viewed the advertising campaign. The reports from the user data sources are provided to a data aggregator that aggregates the reports from the various user data sources. Since each user data source manages its own translation of the hashed user ID to the user IDs associated with the source and generates its own report, the personally identifiable information maintained by each data source is not shared outside of the user data source.

### BRIEF DESCRIPTION OF THE DRAWINGS

FIG. 1 is a high-level block diagram of a computing environment according to one embodiment.

FIG. 2 shows an example data flow for determining estimated viewing statistics for an advertising campaign that protects personally identifiable information within a user data source.

FIG. 3 is a flowchart illustrating steps for computing an estimation model and applying the estimation model to compute estimated viewing statistics for a given advertisement, according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

### Overview

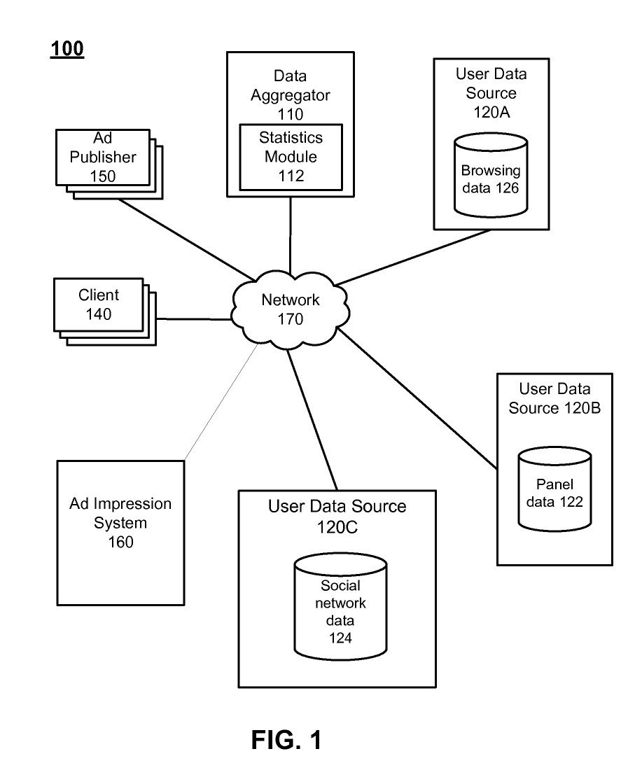

FIG. 1 is a high-level block diagram of a computing environment according to one embodiment. FIG. 1 shows an example environment for an advertising system for determining estimated viewing statistics indicating correlated information from multiple user data sources 120A-120C (generally, 120) without exposing user data from the various data sources.

FIG. 1 illustrates a set of distinct data sources 120A, 120B, 120C storing data obtained based on prior activity of users, a set of client devices 140 used by the users to directly or indirectly provide the data stored by the data sources 120, and a data aggregator 110 that includes a statistics module 112 used to combine and refine the information stored by the data sources 120. FIG. 1 additionally illustrates one or more ad publishers 150 that provide content and advertisements that users can view on the client devices 140, such as videos, images, and the like. As users browse content on the network 170, users visit various ad publishers 150, who generally provide a reference to the client 140 to an advertising server to retrieve an advertisement to accompany the content of ad publisher 150. As an example, the ad publishers 150 include various websites, such as a website producing news, sports, video, music, or other content to users. When the advertisement is provided, an indication of the impression is provided to an ad impression system 160, either directly by the client 140 or indirectly by ad publisher 150.

The various data sources 120 may include different types of data relating to users, and in this example include user data source 120A including browsing data 126, user data source 120B storing panel data 122, and user data source 120C including social network data 124. Embodiments may include any number of user data sources, which may include various types of such user data. The panel data 122 represents the aggregate data provided by a set of households or individual users making up a panel, with respect to a particular website. A surveying panel is a group of people chosen to be statistically representative of the overall audience for some content of interest, such as the viewers of content provided by one of the ad publishers 150. The data tracked for a given panel typically includes information about the number of times that a household in the aggregate, or the individual members of the household, viewed content of interest, such as a particular advertisement, provided by the corresponding ad publisher 150. The data for a panel typically further includes general information on the household itself and/or the individual members thereof. For example, in one embodiment the panel data 122 includes advertisement information such as how many times each member of a particular household was presented with advertisements on the particular ad publisher 150, and demographic information such as the number of members of the household and the age and gender of each member, the location of the household, aggregate household income, and aggregate purchasing behavior (e.g., particular products purchased). The demographic information associated with the households tends to be highly accurate, since the panel members are surveyed and their answers confirmed before they are accepted as members of the panel. However, it may be difficult to determine which particular members of the household viewed the content.

Social network data 124 is derived, directly or indirectly, from use of a social networking system (such as viewing histories of content such as advertisements, videos, images, etc.) and social information (such as connections established between users and profile information). For example, the social network data 124 comprises, for each distinct individual user, how many times that user was presented with a particular advertisement while using the social network, how many times the user “clicked” the advertisement, and declared or manually-specified user information. The declared user information is information about the user, including profile information such as user name, age, sex, birthday, interests (e.g., favorite sport or musical genre), and friends or other connections on a social networking system. Not all of the user information need be manually-specified by the user; some of the information may be inferred by the social networking system based on user activity or relationships (e.g., inferring that the user is interested in basketball based on frequent postings related to basketball, or on his affiliation with basketball-related organizations on the social networking system). Additionally, the social network data 124 may include, for each user, profile information and a list of the user's connections.

The social network data 124 represents a strong understanding of user identity, due to the login-based nature of the social networking system, which requires some validation of user identity. The social network data 124 may contain inaccuracies, for example due to user dishonesty when submitting information (e.g., a false age), though this inaccuracy may be mitigated by flagging and correcting possible inaccuracies based on other known data, as described in more detail below. The social network data 124 is typically rich, containing information on attributes that may have a strong influence on content viewing patterns, such as number of social network friends or number of books read over some recent time period, interactions with friends and content on the social network, stated subjects of interest to the user, and stated education, among many others. However, social network data 124 is also typically highly sensitive, may be personally identifiable, and is typically subject to privacy policies for any sharing of data outside of the social networking system that obtained the data. The social network data 124 reflects the users of the social networking system, which may not accurately reflect users or demographics for a particular impression.

User data source 120A includes browsing data 126, based on aggregated data from user web browsing on a client 140, e.g., via tracking cookies placed on the user's browsing device via HTTP response headers. The browsing data 126 includes, for a given device identifier such as an IP address, a browsing history comprising URLs visited from that device. The browsing data 126 typically lacks as strong a notion of user identity as the social network data 124. On the other hand, browsing data 126 tends to include data on a large number of websites visited, resulting in a larger data set that is typically not subject to privacy policies and that typically does not include other personally identifiable information.

Users use the client devices 140 to provide data to various systems that directly or indirectly provide data to the data sources 120, and to view content, such as content available on an ad publisher 150. The data may be provided via the network 170, which is typically the Internet, but may also be any network, including but not limited to a LAN, a MAN, a WAN, a mobile, wired or wireless network, a private network, or a virtual private network. Large numbers (e.g., millions) of client devices 140 can be in communication with the various data sources 120 at any given time. The client devices 140 may include a variety of different computing devices. Examples of client devices 140 include personal computers, mobile phones, smart phones, laptop computers, tablet computers, and digital televisions or television set-top boxes with Internet capabilities. As will be apparent to one of ordinary skill in the art, other embodiments may include devices not listed above. Different types of client devices 140 may be more suited for communicating with different ones of the data sources 120. For example, devices with web browsers, such as personal computers, smart phones, and the like are particularly suited for interacting with a social networking system and with websites to provide social network data 124 and browsing data 126, whereas television set-top boxes may be more suitable for monitoring and providing panel data 122. Not all of the data stored by the various data sources 120 need be provided directly by the client devices 140 over the network 170. For example, panel members may provide information to a panel system in response to surveys provided via telephone or physical mail.

The data related to viewing of content may be gathered in different manners for the different data sources 120. For example, the panel data 122 on content viewing is usually obtained as a result of installation of software by users who are members of the panel. Specifically, the members of a household that is part of the panel may install software on their personal computers, and the software tracks the content that the household members view and provides this information to the user data source 120B, which stores it as part of the panel data 122. The social network data 124 related to content viewing is captured directly by a social networking system, such as user data source 120C, which has knowledge of the user accesses to social networking content. The browsing data 126 related to content viewing is typically obtained by an advertising network tracking user views of content via cookies supplied as part of HTTP responses and stored on the user devices. Alternatively, the browsing data 126 may be collected by another data aggregation system that is not associated with an advertising network. The browsing data 126 may be organized according to a categorization, for example to identify specific interests or other categories associated with the browsing data. Thus, user visits to a website relating to wildlife may associate the browsing with a nature category.

An advertising server (not shown) receives a request from a client 140 for an advertisement, typically via a referral from another system or service, such as ad publisher 150. When the advertising server receives a request for an advertisement, the advertising server provides an impression indicator to the ad impression system 160. The advertising server may provide the impression directly to the ad impression system 160. Alternatively, the advertising server may provide a tracking pixel to the client 140, or another instruction or resource, causing the client 140 to contact ad impression system 160 and provide the impression indicator to the ad impression system 160. The tracking pixel may be any suitable method for transmitting an ad impression to the ad impression system 160 for ad impression tracking purposes, and may include a script executed at the client 140. In some configurations, the advertising server includes the ad impression system 160.

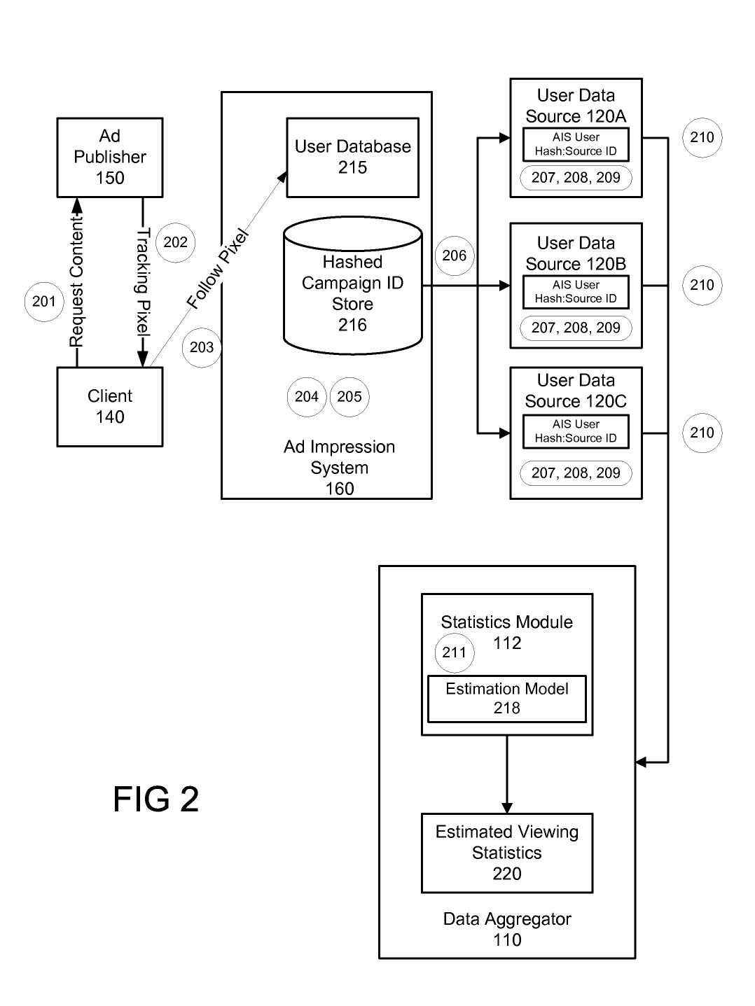

The ad impression system 160 receives advertising impressions from users and identifies a user ID associated with each advertising impression. The ad impression system 160 registers the impression and provides the user ID along with an advertising campaign ID to each of the user data sources 120. The user data sources 120 attempt to identify user data associated with the user ID and, if there is a match, provide demographics information of those matching users to the data aggregator 110 as further described with respect to FIG. 2.

The data aggregator 110 receives demographics information from the user data sources 120 relating to an advertising campaign. The data aggregator 110 includes a statistics module 112 that computes an estimation model using a combination of data from two or more of the data sources 120. In one embodiment, the statistics module 112 additionally provides estimated viewing statistics for a given advertising campaign or other content using the estimation model. The operations of the statistics module 112 are discussed further below with respect to FIG. 2.

It is appreciated that FIG. 1 illustrates a computing environment 100 according to one particular embodiment, and that the exact constituent elements and configuration of the computing environment could vary in different embodiments. For example, although FIG. 1 depicts three specific user data sources—including panel data 122, social network data 124, and browsing data 126—there could be more or fewer user data sources, or user data sources of different types. For example, the environment 100 could include only user data source 120B with panel data 122 and user data source 120C with social network data 124, but not the user data source 120 with browsing data 126. As another example, the data aggregator 110 and statistics module 112, although depicted in FIG. 1 as separate entities, could reside on any system capable of accessing the data stored by the various information sources and protecting the potential confidentiality and privacy of any user demographic information. For example, data aggregator 110 may be a component of ad impression system 160, which may serve advertisements as an ad server.

FIG. 2 shows an example data flow for determining estimated viewing statistics for an advertising campaign. This example data flow protects personally identifiable information within a user data source 120. As described above, when the user requests 201 content from the ad publisher, the client receives 202 a tracking pixel from the ad publisher. The tracking pixel may be separate from any advertisement provided by the ad publisher or an ad server. As described above, the tracking pixel may be any tracking mechanism, such as a script, and may include a resource or a pointer to the ad impression system 160, and the tracking pixel further includes an advertising campaign ID. The advertising campaign ID indicates a particular advertising campaign shown to the user by an ad server or the ad publisher and may correspond to one or more advertisers. Additionally, each advertiser may be associated with one or more advertising campaigns.

The client 140 follows 203 the tracking pixel and accesses the resource in the tracking pixel to access the ad impression system 160 or follows an alternative method of providing tracking to the ad impression system 160, such as by using a script that sends a message to the ad impression system 160. The client 140 may access the ad impression system based on an http redirect of a browser at the client 140 while accessing the ad publisher 150, or via a portion of a webpage provided by the ad publisher 150 that includes the tracking pixel and a resource directing the client to the ad impression system 160. When the client follows 203 the tracking pixel, the client provides a user ID along with the advertising campaign ID to the ad impression system. The user ID may be provided by the client directly when the client accesses the ad impression system 160, or alternatively, the ad impression system 160 may interrogate the client to determine a user ID associated with the ad impression system.

The ad impression may be sent to the ad impression system 160 in various alternate ways. In one configuration, the ad publisher 150 or an advertising server determines a user ID associated with the impression and provides the user ID to the ad impression system 160, rather than the client accessing the ad impression system 160 via a tracking pixel. In another configuration, a browser at the client device 140 is redirected from the ad publisher 150 to the ad impression system 160, rather than receiving a tracking pixel. In another example, the client device receives an iframe in a page provided by the ad publisher 150, and accesses the ad impression system 160 in the iframe.

The user ID is typically a browser ID or other cookie or persistent object on the client 140 identifying the client 140. The user ID may be a combination of various information about the client 140, such as any combination of browser ID, user-agent string, operating system name and version, device type, and so forth that together uniquely or near-uniquely identify the client 140. The user ID may also be log in credentials or another type of cookie for use with a data source 120 or the ad impression system 160. In addition to the user ID being communicated to the ad server through ad publisher 150, the client 140 may directly access a user data source through another reference and provide a user ID to the user data source 120. For example the ad publisher 150 may include a link to a service operated by a user data source 120, for example to provide social networking functionality, or as part of an ad-serving network. In embodiments where the client 140 also communicates with the user data source 120, the client 140 may provide a user ID associated with the ad impression system 160 in addition to any user ID associated with the user data source 120.

Though described with respect to serving an advertisement, the ad impression system 160 and data aggregator 110 may also receive an indication when a user interacts with an advertisement, for example by clicking on an advertisement or otherwise performing an action associated with the advertisement. This type of indication may be used to determine the frequency of click-through or conversion rate of an advertisement, either in aggregate over all users or divided by particular demographic groups. The process may also be used to determine a user's exposure to non-sponsored content, such as broadcast programs.

The ad impression system 160 stores 204 the user ID and the campaign ID associated with the advertisement. The user ID may be stored, for example, in a user database 215. Additional information may also be stored, such as browser information, demographic information, frequency of ad impressions, and other data regarding the impression, campaign, or advertiser. The campaign ID may be stored as a hashed campaign ID in a hashed campaign ID store 216. Though described as a “hash” here for convenience, the hash of the campaign ID is a value derived from the campaign ID that obscures the campaign ID and creates a value (the “hash”) that may be used for matching and identification purposes. Thus, the campaign IDs may be obscured using a hash algorithm, or another non-hashing algorithm that obscures the actual campaign ID. The hashed advertising campaign IDs may be transmitted externally to the ad impression system without revealing details about the advertising campaign. After storing the user ID and campaign ID, the ad impression system 160 retrieves or generates 205 the hashed campaign ID for the campaign.

The ad impression system 160 also obscures the user ID of the user of the ad impression system to generate a user ID hash. The user ID hash generated and maintained at the ad impression system is referred to as an “AIS user hash” to distinguish the ad impression system (AIS) user ID from other user IDs, such as those stored at a user data source 120. The AIS user hash is generated by obscuring at least a portion of information about the user known by or available at the ad impression system 160. The specific user information used to generate the AIS user hash may vary in embodiments, and may include a unique user identifier, a cookie identifier, an email address, a browser ID, an IP address, or other information that the ad impression system maintains about users.

To obtain information from additional user data sources regarding the users that saw the ad impression, the ad impression system provides 206 the AIS user hash and the campaign hash (or campaign ID) to several user data sources. The ad impression system communicates with the user data sources using an application programming interface (API) or other suitable communication channel. This communication channel is encrypted in some configurations.

Each user data source 120 maintains a user ID database that identifies users of the respective user data source 120. An identifier of a user maintained by a user data source is termed the “source ID.” The source ID may be any suitable identifier, such as log-in information, a cookie, an email address, or another item of identifying information about a user. As described above, each user data source 120 also maintains various information about users of the user data source 120 associated with the source IDs. In addition, each user data source maintains a table indicating relationships between AIS IDs and source IDs of the user data source. An AIS ID stored at the user data source 120 may be the actual AIS ID or may be the AIS user hash.

The table matching the AIS ID to the source ID may be generated in various ways. For example, the ad impression system 160 may share a hashed version of user information, such as an email address of a user, with user data sources 120. The ad impression system 160 also indicates the type of user data that was obscured to generate the obscured user data. The type of user data may be, for example, an email address, a browser ID, or other types of data associated with a user. The user data sources 120 generate obscured user data relating to users of the user data source (i.e., the user data associated with source IDs) using the type of user data used by the ad impression system 160 to obscure its user data. The user data sources 120 compare the obscured user information received from the ad impression system 160 with the obscured user data generated about the source IDs determine whether a match exists between the obscured user data of the ad impression system 160 and the obscured user data of the user data source 120. When a match exists, an entry is added to the table matching the AIS ID to the source ID reflecting the match. The user information may be obscured using any suitable technique, such as by hashing or otherwise modifying the underlying user information. In one embodiment, the user data used to obtain a match is a browser ID of the client 140. As another method a client 140 may be redirected to follow a pixel to a user data source 120 from the ad impression system 160. When the client 140 follows the pixel to the user data source 120 from the ad impression system 160, the client 140 may provide the user data source with the AIS user ID or AIS user hash. The user data source 120 may query the client 140 to determine a user ID associated with the user data source 120. For example, the client 140 may maintain a persistent identifier, log-in, cookie, or other means of maintaining an identification with the user data source 120. By querying the client 140, user data source 120 identifies the source ID associated with the client 140 and thereby determines match with the received AIS user ID or AIS user hash. In particular instances, the ad impression system (AIS) ID is not protected and may be provided to the user data source 120 to identify a user along with an impression.

When the user data source 120 receives an indication of an ad impression from the ad impression system 160, the user data source looks up the user ID, determines whether a match 207 exists within the local table, and if so, identifies the source ID of the user associated with the impression. The user data source adds 208 the identified source ID (and/or data about the user associated with the source ID) to a log or other data store retaining information describing advertising impressions. As advertising impressions are received by ad impression system 160, the AIS IDs are transmitted to each user data source 120, and each user data source 120 maintains a log of source IDs associated with the impressions.

In an alternate embodiment, the user data source 120 does not maintain a table of matches between users of the ad impression system and users of the user data source 120. Instead, when an ad impression is received by the ad impression system 160, the ad impression system 160 provides the obscured user information of the user to the user data source 120 and an identification of the type of user information used to generate the obscured user information. As described above, the user data source 120 generates the same type of obscured user information for users of the user data source 120 and identifies a match between the received obscured user information and the generated obscured user information to identify a source user ID associated with the ad impression.

At determined periods or when requested by the data aggregator 110, each user data source 120 generates 209 a report describing demographics data associated with the source IDs of users associated with an impression of a campaign identifier (or in some cases, a hash of an advertising campaign identifier). The demographics report describes information specific to the user data source 120 that generated the demographics report. The report is generalized to remove personally identifiable information. The report from each user data source 120 may be aggregated across many users of the data source 120 to indicate general information associated with the advertisement, or the report may be a log indicating user demographics of each impression. For example, though the user data source may know a source ID of an impression (and therefore a significant amount of personally identifiable information), the report may indicate only that an impression was received at a timestamp (or a generalized timestamp or time range) by a male within an age range and with a particular education level. The report from each user data source 120 may also identify a list of AIS user hashes associated with the report. The AIS user hashes may be associated with specific entries in the report, or may generally be associated with the report without specifically identifying demographics of any AIS user hash. Thus, the information generated in the report provides demographic information for an advertising campaign without revealing personally identifiable data about the users of the user data source 120.

The level of granularity and user demographics generated in the report by each user data source 120 may be standardized or may vary by user data source 120 or by advertising campaign. Accordingly, each advertising campaign may designate particular demographic categories of interest, e.g., particular age ranges, interests, geographical region boundaries, and so forth. Each user data source 120 may review the demographic categories of an advertisement and determine whether to provide a report at the demographic levels requested by an advertiser. This review may be performed manually by an operator of the user data source 120.

Each of the reports from the user data sources 120 are transmitted 210 by the user data sources 120 to the data aggregator 110 to generate estimated viewing statistics of the advertising campaign across the multiple user data sources 120.

The data aggregator 110 receives demographics reports from the user data sources 120. The data aggregator 110 may receive demographics reports when the user data source 120 provides the reports, or the data aggregator 110 may request demographics reports from the user data sources 120. The demographics reports are provided to a statistics module 112 to determine 211 estimated viewing statistics 220 for the received reports associated with a given advertisement or advertising campaign. The statistics module 112 determines and updates estimated viewing statistics 220, which may reflect the gross ratings point (GRP) for an advertisement. The gross rating point is a measure of the advertising reach and impressions of an advertisement for various target demographics. The gross ratings point indicates the demographics of users viewing an advertisement and the numbers of such users. The GRP may reflect a number of impressions or may determine the number of unique viewers of an advertisement.

To generate the estimated viewing statistics 220, the statistics module 112 derives an estimation model 218 from sets of demographics data from the user data sources 120. The statistics module 112 receives the various types of user data from the user data sources 120, such as panel data 122, social network data 124, and browsing data 126 as reflected in the demographics reports. The statistics module 112 then combines the different data using a data integration technique, the specifics of which differ in different embodiments, resulting in an estimation model 218. For example, in one embodiment the statistics module 112 combines a report reflecting the panel data 122 from one data source 120 with a report reflecting the social network data 124 from another data source 120.

In one embodiment, the statistics module 112 need not accept the data provided by the user data sources 120 as-is, but may instead modify the data for greater accuracy. That is, either the statistics module 112 can modify the data sets provided by the different data sources 120 before combining the data sets, or the user data sources 120 themselves can perform the modifications before providing the data sets to the statistics module 112. For example, a portion of the user-entered information within the social network data 122 may be rejected or modified based on other social data associated with that user, where the other social data indicates that the portion is inaccurate. As a specific example, a particular user may list herself in her profile as being 107 years old, but if the majority of her friends are aged 20-24, she has recently listed a college as her current educational institution, and she has a high school graduation date three years prior to the current date, her age might be adjusted to the most probably correct age (e.g., 21) before the user data source 120 generates a report that includes data describing the user or before the statistics module 112 combines unaltered social network data 122 with any other data set.

Different algorithms may be used in different embodiments to perform the derivation of the estimation model 218. For example, possible techniques include supervised machine learning, Bayesian techniques, or weighting segments, each of which is known to one of skill in the art. “Ground truth” for training the models may be supplied by, for example, performing a comprehensive survey regarding viewing of some subset of the content.

The estimation model 218, in essence, maps the viewing statistics for the different data sets 122, 124, 126 used to train the model to a single set of statistics that is more likely to be accurate. Thus, for given content for which actual viewing statistics have not been verified, such as the demographic reports provided by user data sources 120, viewing statistics produced by advertising impressions can be provided as inputs to the estimation model 218, which outputs a set of estimated viewing statistics 220 with greater probable accuracy than any input viewing statistics that may otherwise have been generated by individual user data sources.

In one embodiment, the estimated viewing statistics 220 produced by the estimation model 218 for a given advertisement or other content comprise, for each demographic attribute of interest (or combinations of demographic attributes, such as males aged 15-19), estimated viewing statistics. In one embodiment, the estimated viewing statistics 220 include the reach and frequency of the advertisement of interest. As an example for a hypothetical set of data, the viewing statistics could include, in part, the following data, which illustrates example estimated statistics for various demographic attributes (i.e., age groups 15-19 and 20-25, males, females, and those interested in basketball):

| Attribute | Reach | Frequency |
|---|---|---|
| Age 15-19 | 15,282 | 2.83 |
| Age 20-25 | 20,969 | 3.4 |
| Sex: Male | 25,892 | 2.38 |
| Sex: Female | 35,223 | 5.4 |
| Interest: | 12,347 | 1.3 |
| Basketball | | |

Thus, in viewing the estimated statistics of this example, the advertiser associated with the advertisement could determine that the advertisement likely fared considerably better with women than with men, and somewhat better with the age group 15-19 than with the age group 20-25, for example, in addition to determining the estimated reach and frequency values themselves.

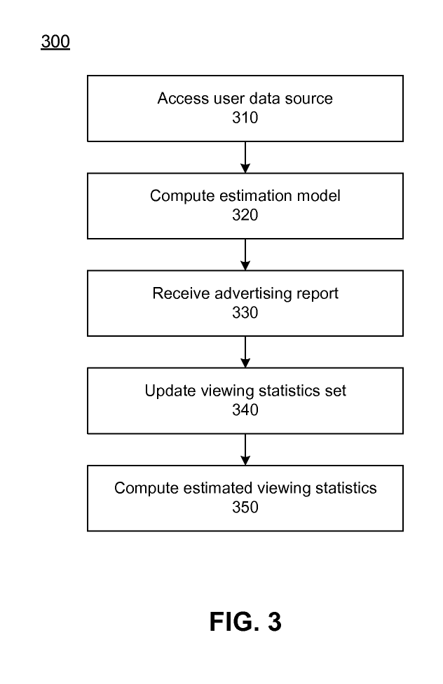

FIG. 3 is a flowchart illustrating steps performed by the statistics module 112 when computing the estimation model 218 and applying the estimation model to compute estimated viewing statistics 220 for a given advertisement, according to one embodiment. In step 310, the statistics module 112 accesses user data source information from the various user data sources 120.

In step 320, the statistics module 112 computes the estimation model 218 from the demographics data of the user data sources using one of the techniques noted above, such as machine learning or Bayesian techniques. The estimation model 218 can be viewed in one example as being representative of the social network data 124, adjusted by the panel data 122, thereby tailoring the social network data to a representative audience.

With the estimation model 210 having been derived, the statistics module 112 can apply the estimation model 210 to estimate the viewing statistics for a given advertisement, or other content of interest. Specifically, the statistics module 112 applies a viewing statistics set to the estimation model 210. The viewing statistics set reflects the users who are associated with having viewed a particular advertisement.

To generate the viewing statistics set, when the statistics module 112 receives demographics reports for an advertising campaign 330, the statistics module 112 analyzes the demographics report and updates 340 a viewing statistics set representing the users who viewed the advertising campaign as provided by each user data source 120.

The data aggregator 110 provides the updated viewing statistics set (i.e., the updated set of users indicated by the reports) to the estimation model 210, which computes 350 estimated viewing statistics 220 for the advertisement. As described above, such estimated viewing statistics 220 include, for values of each demographic attribute of interest (e.g., various age groups, or male/female groups), estimated viewing statistics, such as the estimated reach and frequency of the advertisement.

In this way, the ad impression can be provided to several user data sources 120, and each data source may determine matching users and generate demographics information about the advertising impression. This permits each user data source 120 to provide what demographics information it has stored to inform demographics of the advertising campaign as a whole. By matching AIS user information to source IDs and user information known by each user data source 120, estimated viewing statistics 220 can be compiled across multiple user data sources for a single advertisement without providing detailed information to the user data sources 120 or requiring the user data sources 120 to trust another entity with personal data maintained by the user data source.

### SUMMARY

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments are intended to be illustrative, but not limiting, of the scope of the embodiments, which is set forth in the following claims.

What is claimed is:

1. A method comprising:
receiving a user identifier associated with an advertising impression of an advertising campaign;
generating obscured user data associated with the received user identifier;
sending the obscured user data and an identifier of the advertising campaign to a plurality of user data sources;
receiving, from each of the plurality of user data sources, a demographic report, wherein the demographics report:
describes user demographics of advertising impressions associated with the advertising campaign, and
includes demographic information stored at the user data source that relates to the obscured user identifier sent to the user data source; and
based at least in part on the received demographics report, updating one or more estimated viewing statistics for the advertising campaign, the estimated viewing statistics associated with viewership and demographics of one or more users who have viewed the advertising campaign.

2. The method of claim 1, wherein the obscured user information sent to the plurality of data sources comprises hashed user information associated with the user identifier.

3. The method of claim 1, wherein the identifier of the advertising campaign sent to the plurality of user data sources comprises a hashed campaign ID.

4. The method of claim 1, wherein sending the user identifier and the identifier of the advertising campaign comprises providing a redirection to a client associated with the advertising impression, the redirection directing the client to contact at least one of the plurality of user data sources.

5. The method of claim 1, further comprising:
hashing an item of user information to determine a hashed user identifier; and
sending the hashed user identifier to at least one user data source of the user data sources, wherein the at least one data source is configured to determine a match between the obscured user data and a user identifier stored at the user data source.

6. A method comprising:
receiving, obscured user data associated with an advertising impression of an advertising campaign;
identifying a matching user from a plurality of users in a user database, the matching user being associated with data source user information corresponding to the received obscured user data;
adding the advertising impression and an identifier of the matching user to a log of advertising impressions associated with the advertising campaign;
generating, by the user data source, a demographics report for the advertising campaign based on the log of advertising impressions, the demographics report including demographic information corresponding to the users listed in the log of advertising impressions and the received obscured user data;
sending, by the user data source, the demographics report to a data aggregator configured to receive a plurality of demographics reports from a plurality of user data sources and generate estimated viewing statistics for the advertising campaign using the plurality of demographics reports.

7. The method of claim 6, wherein the received obscured user data is an identifier of a user at an ad impression system, the method further comprising:
maintaining a table that identifies a relationship between user identifiers at the ad impression system and users of the user data source; and
wherein identifying the matching user in the user database comprises a look-up in the table using the received user identifier.

8. The method of claim 7, wherein the table identifying the relationship between user identifiers comprises obscured user information.

9. The method of claim 7, wherein maintaining the table comprises receiving a redirected browser from a client associated with a user, the redirected browser providing an indication of the user identifier of the user at the ad impression system.

10. The method of claim 6, wherein the generated demographics report includes a log indicating demographics of each advertising impression of the log of advertising impressions.

11. A non-transitory computer-readable medium comprising instructions that when executed by a processor cause the processor to perform steps comprising:
receiving a user identifier associated with an advertising impression of an advertising campaign;
generating obscured user data associated with the received user identifier;
sending the obscured user data and an identifier of the advertising campaign to a plurality of user data sources, each user data source maintaining a different set of user data;
receiving, from each of the plurality of user data sources, a demographic report, wherein the demographics report:
describes user demographics of advertising impressions associated with the advertising campaign, and
includes demographic information stored at the user data source that relates to the obscured user identifier sent to the user data source; and
based at least in part on the received demographics report, updating one or more estimated viewing statistics for the advertising campaign, the estimated viewing statistics associated with viewership and demographics of one or more users who have viewed the advertising campaign.

12. The computer-readable medium of claim 11, wherein the obscured user information sent to the plurality of data sources comprises hashed user information associated with the user identifier.

13. The computer-readable medium of claim 11, wherein the identifier of the advertising campaign sent to the plurality of user data sources comprises a hashed campaign ID.

14. The computer-readable medium of claim 11, wherein sending the user identifier and the identifier of the advertising campaign comprises providing a redirection to a client associated with the advertising impression, the redirection directing the client to contact at least one of the plurality of user data sources.

15. The computer-readable medium of claim 11, wherein the instructions further cause the processor to:
hashing an item of user information to determine a hashed user identifier; and
sending the hashed user identifier to at least one user data source of the user data sources, wherein the at least one data source is configured to determine a match between the obscured user data and a user identifier stored at the user data source.

16. A non-transitory computer-readable medium comprising instructions that when executed by a processor cause the processor to perform steps comprising:
receiving obscured user data associated with an advertising impression of an advertising campaign;
identifying a matching user from a plurality of users in a user database, the matching user being associated with data source user information corresponding to the received obscured user data;
adding the advertising impression and an identifier of the matching user to a log of advertising impressions associated with the advertising campaign;
generating a demographics report for the advertising campaign based on the log of advertising impressions, the demographics report including demographic information corresponding to the users listed in the log of advertising impressions and the received obscured user data;
sending the demographics report to a data aggregator configured to receive a plurality of demographics reports from a plurality of user data sources and generate estimated viewing statistics for the advertising campaign using the plurality of demographics reports.

17. The computer-readable medium of claim 16, wherein the received obscured user data is an identifier of a user at an ad impression system, and the instructions further cause the processor to perform steps of:
maintaining a table that identifies a relationship between user identifiers at the ad impression system and users of the user data source; and
wherein identifying the matching user in the user database comprises a look-up in the table using the received user identifier.

18. The computer-readable medium of claim 17, wherein the table identifying the relationship between user identifiers comprises obscured user information.

19. The computer-readable medium of claim 17, wherein maintaining the table comprises receiving a redirected browser from a client associated with a user, the redirected browser providing an indication of the user identifier of the user at the ad impression system.

20. The computer-readable medium of claim 16, wherein the generated demographics report includes a log indicating demographics of each advertising impression of the log of advertising impressions.
